(19) United States
(12) Patent Application Publication
(10) Pub. No.: US 2024/0083618 A1
(43) Pub. Date: Mar. 14, 2024

(54) LABELING DEVICE

(71) Applicant: Krones AG, Neutraubling (DE)

(72) Inventor: Andreas MEYER, Nittenau (DE)

(21) Appl. No.: 18/463,220

(22) Filed: Sep. 7, 2023

(30) Foreign Application Priority Data
Sep. 9, 2022 (DE) 10 2022 123 019.8

(51) Int. Cl. B65C 9/40; B65C 9/22

(52) U.S. Cl. CPC B65C 9/40; B65C 9/2204; B65C 2009/402

(57) ABSTRACT

The present disclosure provides a fully automated labeling device which comprises: a transport device for transporting the objects, a label providing device, a label transfer device for transferring labels, a gluing device for applying glue onto the labels, an artificial intelligence open-loop and/or closed-loop control device, and a sensor system having a plurality of sensor units for monitoring a plurality of operating parameters and quality parameters, and outputting a plurality of sensor data. The open-loop and/or closed-loop control device is designed to obtain the sensor data from the sensor system and to fully automatically control and/or regulate the setting and adjusting of the operating parameters on the basis of these sensor data.

### CROSS REFERENCE TO RELATED APPLICATION

The present application claims priority to German Patent Application No. 10 2022 123 019.8 filed on Sep. 9, 2022. The entire contents of the above-listed application are hereby incorporated by reference for all purposes.

### TECHNICAL FIELD

The present disclosure relates to a labeling device for labeling objects, such as containers, in which relevant operating parameters are set on the basis of sensor data.

### BACKGROUND

In filling systems for beverages, containers, such as bottles, cans, etc., are treated in several successive process steps. In general, the process steps are carried out in separate treatment stations which can be assembled, for example, as modules of a common system concept. A container treatment system for glass bottles or plastic bottles, for example made of polyethylene terephthalate (PET), polypropylene (PEP), etc., may comprise, for example, a blow mold device, filling device, carbonization device, closing device, labeling device, packaging device, cleaning device, pasteurization device, inspection device, etc., as separate, modular treatment stations.

### SUMMARY

The individual treatment stations, which perform successive process steps, are generally connected in series, wherein one or more transport devices provide the transportation of the containers from the treatment stations to the respective downstream treatment stations.

There is a clear trend to automate systems having the mentioned treatment stations and, thus the treatment stations themselves, as fully as possible and to digitize their operation.

In a labeling device, labels are applied continuously with high output to continuously fed articles, containers or bundles of containers. The containers may be glass bottles, plastic bottles, in particular PET bottles, cans or can-like containers or containers manufactured from pulp, which are filled with liquid or solid food, medical or cosmetic products, hygiene products or the like. The labeling device generally comprises a labeling assembly which is often designed in a modular manner.

Such labeling assemblies for labeling machines, in particular also for labeling machines of the rotary type, for labeling bottles or similar containers with labels, in particular also those made of paper, using cold glue, are known in the prior art. In principle, such assemblies comprise at least one plate or glue segment carrier, also referred to as plate carousel, which can be driven so as to revolve around a vertical assembly axis and on which a plurality of label plates or glue segments are provided, each forming at least one label holder or support surface.

The plates or glue segments are each designed to be pivotable in a controlled manner about a separate pivot axis. During labeling, the plates or glue segments are first moved past a gluing station for providing a glue application on the label support surface of said plates or glue segments and then moved past at a label dispensing station with each revolution of the carousel, wherein one label each is taken over. The labels coated with glue are each transferred to the containers moved past the labeling assembly, for example, by means of a gripping cylinder.

However, conventional labeling devices can hardly be integrated in fully automated systems.

It is the object of the present disclosure to provide a labeling device suitable for integration in fully automated systems, which reliably ensures a labeling of objects with high quality.

The above-mentioned object is achieved by providing a labeling device for objects according to claim 1. The objects may be articles (for instance packages made of organic material or plastic material), containers or bundles of containers, wherein the containers may, for example, be bottles (for instance made of glass or plastic) or cans or can-like containers. The labeling device comprises:
a transport device for transporting the objects;
a label providing device;
a label transfer device for transferring labels;
a gluing device for applying glue (for example, labeling glue, conventional high-viscosity cold glue (15,000-150,000 mPa), water based low-viscosity cold glue (20-15,000 mPa) or alternative adhesives such as UV-curing or two component glue, to the labels;
an artificial intelligence open-loop and/or closed-loop control device; and
a sensor system having a plurality of sensor units for monitoring a plurality of production and quality parameters, and outputting a plurality of sensor data.

Suitable spray head for applying the glue are, for example, spray systems from the cigarette industry (spraying of cold glue and hot glue); the application can take place both vertically (from the top to the bottom) and horizontally (from the left to the right or right to the left)—the vertical application (from top to bottom) may be preferred, since the vectors of all forces optimally add up and the process is thus more robust because less dirt can build up at the nozzle.

The artificial intelligence open-loop and/or closed-loop control device is designed to obtain the sensor data from the sensor system and to fully automatically and digitally control and/or regulate the setting and adjustment of operating parameters of the operation of the labeling device on the basis of these sensor data. The operation of the labeling device may comprise transporting the objects with the transport device, dispensing of labels by the label providing device, transferring of labels by the label transfer device and applying glue onto the labels by the gluing device. Operating parameters include, in particular, those which relate to the glue (e.g., quantity, composition, positioning/arrangement of the glue dots/lines or the glue pattern on the labels) and those which relate to the labels (for instance positioning on the objects, pressing-on by brushing/rolling on).

In the case of UV-curing glue, the output of UV lamps/LED lamps used for glue curing may be an operating parameter. The UV output can be regulated in a fully automated manner. The artificial intelligence open-loop and/or closed-loop control device can regulate the UV lamps/LED intensity as needed, for example, upward. The lamp spectrum can also be monitored continuously, for example, to be able to determine in good time when the service life of the lamp/LED approaches the end of service life or the spectrum shifts.

The artificial intelligence open-loop and/or closed-loop control device can be trained to immediately cause measures for changing certain operating parameters when certain errors are detected; but it can continue to learn (on-the-fly) during operation of the labeling device. The sensor system takes over the monitoring and, if applicable, recording of all parameters that are relevant for operation and quality, and, in particular, an outgoing goods inspection, the feedback of which to the artificial intelligence open-loop and/or closed-loop control device allows the latter to learn during operation and to optimize the operating process, whereby, in particular, downtimes can be kept low and the quality of the labeling can be increased compared to the prior art. Time and cost-intensive manual servicing can be reduced to a minimum. Provision processes of consumer goods can be initiated automatically and “just in time.” In addition, in the fully automatic operation of the labeling device, the quantity of consumables used, such as the glue required for labeling, can be optimized in a needs-based manner, and a waste of material can thus be avoided.

A labeling device provided in this way can be operated fully automatically and can be integrated easily as a module into a fully automated system, for example, a fully automated system for beverage production. Thus, the labeling device according to the disclosure can be provided as part of a machine block together with further components, such as for example a stretch blow molding machine for producing containers and/or a filling machine for filling the containers and/or a closing machine for closing the filled containers. It is understood here that at least the machines comprised by a machine block for filling, closing and labeling are fastened to a common machine frame and/or that their machine frames can be mechanically fixed to one another for production operation, for example by screwing, clamping or the like. The machine frames may be composed of a plurality of modules, mounting platforms or the like that can be fixedly connected to one another for individual machines, treatment devices and/or transfer starwheels of the machine block. A container transfer between the individual machines of the machine block is possible in a space-saving and precise manner by means of transfer starwheels, such as, for example, infeed starwheels and discharge starwheels, conveyor screws or the like.

The labeling device may comprise a central drive in the form of a motor unit, for example a servo motor, which drives the label transfer device. The central drive can thus drive a plate carousel which can be driven about an axis of rotation with at least one plate pivotable by the central drive and designed to take over labels provided by the label providing unit. Furthermore, the plate carousel and the one or more plates may be designed to directly transfer the labels to the containers to be labelled without play, without an additional gripping cylinder being necessary for labeling. The one or more plates may each be designed as vacuum plates with a plurality of suction openings or suction cups on the support surface of the vacuum plate for holding the labels. The labels are held by a negative pressure generated by a vacuum supply unit during their movement on the plate carousel after being retrieved from the label providing device until the transfer to the containers to be labelled.

The one or more plates can be moved via roller levers with rollers (cam rollers), wherein each plate is associated with a roller lever and the rollers run in a control cam. The roller levers are connected to plate shafts for driving the plates via the central drive. The control cam is designed, for example, as a (guide) curve groove or rail above or below the plate carousel in or on a corresponding fixed control cam plate.

The gluing device of the labeling device may comprise a plurality of, in particular, individually controllable, glue nozzles by means of which a variable glue pattern can be printed onto glue application surfaces of the labels. By using such a gluing device operating according to the inkjet method (Gluejet/GlueLite method), gluing of the labels can take place quickly and reliably as well as variably. For example, wet glue is sprayed onto the labels in the gluing device, the thus glued labels are fed from the label transfer device to the objects to be labelled and pressed onto the objects by means of a sponge.

The operating parameters which are to be monitored by the sensor system and set and adjusted by the artificial intelligence open-loop and/or closed-loop control device may comprise parameters for the gluing device, which comprise the quantity, the pattern (lines, dots, distances, arrangement, etc.) and the composition of the glue applied to the labels, and which can be changed by the artificial intelligence open-loop and/or closed-loop control device in accordance with a subset of the sensor data. The optimized use of the glue is of particular importance for a reliable correct labeling without the labels protruding from or even falling off the objects to be labelled. Here, in particular the composition of the glue plays an important role. If, for example, a labeling that does not meet the applied quality criteria is recognized at an outgoing goods inspection, which is comprised in the sensor system, the artificial intelligence open-loop and/or closed-loop control device can, in particular, cause a change in the composition of the glue used for labeling.

The use of artificial intelligence is essential for the complex fully automated operation of the labeling device. The artificial intelligence open-loop and/or closed-loop control device of the labeling device may be designed for machine learning. According to developments, the artificial intelligence open-loop and/or closed-loop control device of the labeling device comprises at least one transformer and/or an artificial neural network, in particular, one of a deep (learning) neural network, multilayer perceptron, convolutional neural network and recursive neural network. The deep (learning) neural network is characterized by a plurality of hidden layers. A machine is enabled by deep learning to improve its capabilities independently and without human involvement and make decisions by extracting and classifying patterns from existing data and information. The insights obtained can in turn be correlated with data and linked in a broader context. Finally, the machine is capable of making decisions based on these links. By continuously questioning the decisions, the information links are given certain weightings. If decisions are confirmed, their weighting increases; if they are revised, the weighting decreases. There are always several hidden intermediate layers and links between the input layer and the output layer. The actual output is decided by the number of intermediate layers and their updated link. The multilayer perceptron represents a relatively simple, robust neural network in which all nodes are fully connected. The convolutional neural network is based on convolutions instead of matrix multiplication. The recursive neural network allows feedback of a neuronal layer to a preceding one. A transformer has neither a convolutional neural network nor a recursive neural network, but is based on the concept of self-attentiveness. However, the transformer can interact with a convolutional neural network or a recursive neural network.

The sensor system is indispensable for the labeling device according to the disclosure, since the artificial intelligence open-loop and/or closed-loop control device could not control/regulate a fully automated operation of the labeling device without the sensor data supplied by the sensor system. According to a development, the sensor system comprises first sensor units for monitoring parameters related to the glue and second sensor units for monitoring parameters related to the labels. Furthermore, the sensor system of the labeling device can comprise third sensor units for monitoring temperatures of elements of the labeling device, fourth sensor units for monitoring pump pressures (for example, pressures of glue pumps or vacuum pumps), fifth sensor units for monitoring consumables (such as glue, additives, lubricating oils or cleaning liquids), sixth sensor units for monitoring cleaning processes, and seventh sensor units for monitoring environmental parameters (for example, ambient pressure, temperature or humidity, or contamination).

It may also be provided that the artificial intelligence open-loop and/or closed-loop control device controls operating parameters according to the material and the surface condition of the objects to be labelled. Information about the material and the surface condition of the objects to be labelled can be input separately into the artificial intelligence open-loop and/or closed-loop control device and/or can be obtained via corresponding further sensor units.

The first sensor units for monitoring parameters related to the glue may comprise a sensor unit for monitoring the composition of the glue. Furthermore, they may comprise a sensor unit for monitoring the quantity of glue applied to the labels, a sensor unit for monitoring the viscosity of the glue, a sensor unit for monitoring the particle size of particles of the glue, a sensor unit for monitoring the temperature of the glue, and a sensor unit for monitoring the pattern of the glue applied to the labels.

The second sensor units for monitoring parameters related to the labels may comprise a sensor unit for monitoring the adhesion of the labels to the objects, and a sensor unit for monitoring the positioning of the labels on the objects and thus serve/contribute to the outgoing goods inspection. Furthermore, the second sensor units may comprise filling state sensors for (label magazines) of the label providing device, wherein the artificial intelligence open-loop and/or closed-loop control device may be designed, in particular, for controlling/regulating an automatic switching between different magazines for retrieval, whereby comparatively small magazines are used and/or a continuous working operation can even be maintained in the event of a malfunction of a magazine by automatically switching to a functional Magazine.

It is understood that some of the above-mentioned sensor units may be designed at least partially logically and/or physically integrated in a suitable manner. Temperature sensors, pressure sensors and image recording devices may be suitably used for the sensor units. Information about a wide variety of sensor data may be suitably provided to a user via image display devices.

As already stated above, the labeling device provided here is suitable for easy integration into a fully automated system for beverage production. Thus, a fully automated system for beverage production having the labeling device according to one of the examples described above is also provided here.

### BRIEF DESCRIPTION OF THE FIGURE

Further features and exemplary embodiments as well as advantages of the present disclosure are explained in more detail below with reference to the single FIGURE. It is understood that the embodiments do not exhaust the scope of the present disclosure. It is further understood that some or all of the features described below can also be suitably combined with one another in other ways.

FIG. 1 shows a labeling device having an artificial intelligence open-loop and/or closed-loop control device and a sensor system according to an embodiment of the present disclosure.

### DETAILED DESCRIPTION

The present disclosure provides a labeling device for labeling objects, for example containers such as bottles or cans or bundles of containers, which allows fully automated and digitized operation of the labeling device by providing an artificial intelligence open-loop and/or closed-loop control device and a sensor system that is in data exchange with said artificial intelligence open-loop and/or closed-loop control device.

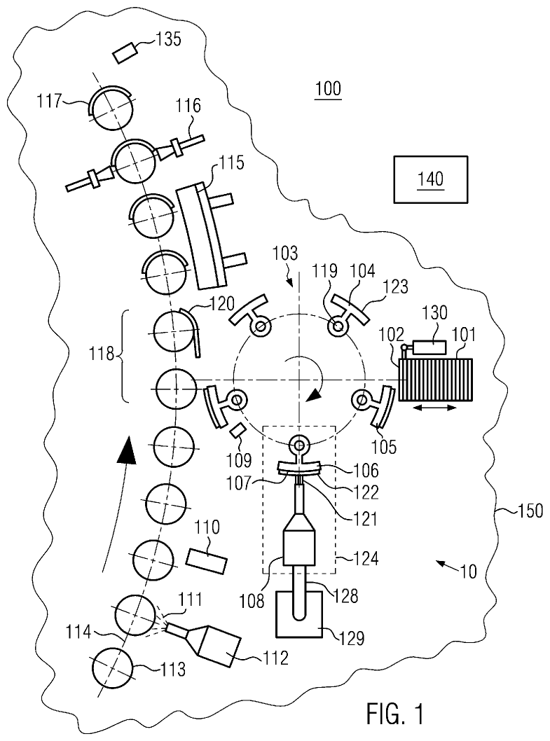

An exemplary embodiment for such a fully automated labeling device according to the disclosure is shown in plan view in FIG. 1.

The labeling device 100 shown in FIG. 1 comprises a transport device 114 designed as a container table, along which objects to be labelled (hereinafter by way of example containers) 113 or bundles circulate on a plurality of holders (not shown) which are rotatable about themselves on a curved path. A pretreatment unit 112 may be provided, which prepares the containers 113 to be labelled for the labeling by cleaning, pre-moistening 111 or subjecting the container surface to a blow-off, a heat and/or radiation and/or plasma and/or corona treatment. Furthermore, a sensor unit 110 may be provided which measures the condition of the surface to be labelled, e.g., smooth, rough, etc., and/or environmental conditions such as, for example, an ambient temperature or atmospheric humidity, and transmits the measured values to an artificial intelligence open-loop and/or closed-loop control device 140 for controlling the labeling device 100. The sensor unit 110 is shown by way of example as part of a comprehensive sensor system 150 for monitoring operating and quality parameters. The sensor system 150 comprises a plurality of further sensor units (see description below), which are not all shown in detail in FIG. 1 for reasons of clarity.

Furthermore, a rolling unit 115 and/or a brushing unit 116 may be provided downstream of the labeling position 118 to completely apply the label 120 placed on the container and press it on. The position of the labels 120 on the finished labeled containers 117 can be checked by means of a sensor unit 135. The containers 117 provided with the labels 120 are then transferred to a subsequent treatment station, for example, a filling station for filling the containers 117 with a liquid food.

The labeling device 100 further comprises a labeling assembly 10. The labeling assembly 10 comprises a transfer device 103 designed as a plate carousel with at least one plate 104-106. The plate carousel 103 has a plurality of plates 104-106 revolving about an axis of rotation of the plate carousel 103, which plates are in turn designed to be pivotable about their own, eccentrically mounted pivot axes 119. On their side facing outwards, the plates have a support surface 123 which may be designed to be large enough that it can accommodate a plurality of different label formats.

During its revolution about the axis of rotation of the plate carousel 103, the initially unloaded plate 104 is moved past a label providing unit 101 in the form of a label box, which is arranged on the periphery of the plate carousel 103 and pivoted such that the support surface 123 of the plate takes over the foremost label 102 presented with the image side from the label box 101. If the plates 104-106 are designed as vacuum plates, this taking-over is reliably possible even without prior gluing of the support surface 123. To be able to adjust the distance of the foremost label 102 to the plate carousel 103, the label box 101 may be designed to be controllable via a pneumatic cylinder 130.

A plate 104 can take over the label from the label providing unit 101 by means of a plurality of suction openings of the plate 104 via negative pressure. For this purpose, the plate 104 is supplied with negative pressure via a vacuum system. The vacuum system may comprise a vacuum pump, a side channel blower, a Venturi nozzle or a Coanda nozzle. The vacuum system may be designed to be controllable in such a way that the plate 104 can be acted upon by negative pressure in dependence on the position of the plate 104 during the revolution around the plate carousel 103.

Since the labels 102 are provided with their image side forward, they also come to rest on the support surface 123 of the plate 105 with the image side. Thus, the glue application surface 122 of the labels 107 transported by the plates 105 and 106 faces away from the support surface of the respective plate. The glue application surface of the label 107, which is thus facing outwards, can therefore be glued directly on the plate by means of a gluing device 124 arranged on the circular path of the plates 104-106, i.e., on the circumference of the plate carousel 103.

The gluing device 124 may operate according to the inkjet method. The gluing device 124 may have a plurality of controllable glue nozzles which are arranged in such a way with respect to the circular path of the label back side of the label transported by the plate that the glue to be applied is injected onto its glue application surface when the label is moved past. This can be done, for example, by punctiform or linear application of glue. When the label is pressed onto the container, the applied dots or lines finally widen to glue surfaces which allow the label to adhere securely to the container surface. The glue nozzles may operate, in particular, according to the inkjet principle, wherein one or more rows of glue nozzles aligned perpendicular to the direction of movement of the glue application surface are activated in a targeted manner in order to achieve a desired glue pattern, i.e., a desired dosage and distribution of the glue applied to the glue application surface. Alternatively, the gluing device 124 could be provided for surface gluing of the glue application surface 122 of the label 107 with the aid of a gluing roller. The glued labels or the glue applied to the labels can be checked with a sensor unit 109.

When using a glue printer 108, cold glue in the form of a glue jet 121 is sprayed from a plurality of glue nozzles directly onto the glue application surface 122. For this purpose, the glue application surface 122 is preferably moved past the openings of the glue nozzles at a constant distance by revolving and pivoting the plate 106. By selectively controlling the glue nozzles, for example, according to the DoD principle (drop-on-demand), an approximately arbitrary glue pattern can be printed onto the glue application surface 122 in superposition with the plate movement. In particular, exactly the required quantity of cold glue can be printed, so that a glue return can be completely dispensed with. The glue is supplied via a glue feed line 128 in a controlled manner in the required quantity from a deformable storage device 129. As glue, low-viscosity glues, glues with a viscosity of between 20 and 80,000 or 150,000 mPa and casein or dispersion glues with an optimal processing temperature between 18° C. and 34° C. can be used. Controlling the temperature of the glue or the glue system to about 35-45° C. may possibly be necessary, since the nozzle heats up over time. The glue pattern may migrate as the nozzle system/head heats up. With a continuous controlling of the temperature to a constant temperature (complete system including pump, nozzle system, glue supply, lines, etc.), this can be prevented. If necessary, the temperature can also be set to lower or higher ° C. values.

Since the cold glue is applied to the glue application surface 122 pointing outwards, no gripper cylinder is required for placing the now glued labels 107 onto the containers 113 to be labelled. Instead, the labels are placed from the plates 104-106 directly onto the containers 113 moved past the labeling position 118 and are rolled onto said containers by a rotational movement of the supports of the container table 114. For this purpose, the plates are moved past the container surfaces and pivoted in such a way that the entrained labels, in combination with the rotational movement of the containers and their revolution around the container table, are unrolled onto the container surfaces.

In another embodiment, hot glue is printed on the labels 120 instead of cold glue with a corresponding alternative glue printer.

The revolving movements of the plates 104-106 and the supports of the container table 114 can be controlled by means of controllable drives (not shown in FIG. 1) via the artificial intelligence open-loop and/or closed-loop control device 140 of the labeling device 100. The pivoting movements of the plates 104-106 can be controlled and/or regulated by means of corresponding control cams and rolling levers by means of the artificial intelligence open-loop and/or closed-loop control device 140. The vacuum supply and the operation of the glue nozzles can also be controlled/regulated via the artificial intelligence open-loop and/or closed-loop control device 140.

It should also be mentioned that the labeling device 100 shown in FIG. 1 may have more than one labeling assembly 10. Thus, it may, for example, have a labeling assembly 10, which is oriented substantially horizontally, and a further labeling assembly which is designed to be inclined relative to the horizontal, for simultaneous or successive labeling of different regions of one and the same container.

Essential to the disclosure, the labeling device 100 shown in FIG. 1 comprises an artificial intelligence open-loop and/or closed-loop control device 140 and a sensor system 150 having a plurality of sensor units. The interaction of the artificial intelligence open-loop and/or closed-loop control device 140 with the sensor system 150 enables the fully automated operation of the labeling device 100. In order to control the complex operating process in a fully automated manner, the artificial intelligence open-loop and/or closed-loop control device 140 comprises, for example, a transformer and/or trainable neural networks. In particular one or more deep (learning) neural networks, multi-layer perceptrons, convolutional neural networks and/or recursive neural networks may be used, which obtain data as input data that are obtained on the basis of sensor data supplied by the sensor units of the sensor system 150. Output data from these neural networks are used in control instructions for setting and adjusting operating parameters. For example, the transformer can be used to classify faults and perform corresponding fault analysis and troubleshooting based on this classification.

The plurality of sensor units may comprise first sensor units for monitoring parameters related to the glue (for example, comprising the sensor unit 109) and second sensor units for monitoring parameters related to the labels 120 (for example, comprising the sensor unit 135). Thus, the composition of the glue, the amount of the glue applied to the labels, the viscosity of the glue, the particle size of particles of the glue, the temperature of the glue and the pattern of the glue applied to the labels (for example, in part with the aid of cameras and/or photoelectric sensor units) can be monitored by the first sensor units, and these parameters (and/or optionally further operating parameters) can be set and changed accordingly by the artificial intelligence open-loop and/or closed-loop control device 140 based on the data supplied by the first sensor units. For example, the glue volume of a print head can be varied in dependence on a glue pressure in the print head detected by a sensor unit of the first sensor unit to compensate for pressure fluctuations.

The adhesion of the labels 120 to the containers 113 and the positioning of the labels 120 on the containers 113 (for example, by means of cameras and/or photoelectric sensor units) can be monitored by the second sensor units. Operating parameters affecting the adhesion and positioning of the labels 120 to/on the containers 113 can be set and changed by the artificial intelligence open-loop and/or closed-loop control device 140 based on the data supplied by the second sensor units. For example, in the case of a non-satisfactory adhesion of the labels 120 to the containers 113, detected by the sensor units for monitoring the adhesion of the labels 120 to the containers 113, the artificial intelligence open-loop and/or closed-loop control device 140 can cause a different composition of the glue to be applied to the labels 120, for example, in the case of a two-component glue, a changed mixture of the two components.

If, for example, it is determined with the aid of the second sensor units that labels 120 protrude from the containers 113, the artificial intelligence open-loop and/or closed-loop control device 140 can determine based on corresponding data supplied by other sensor units, whether the glue nozzle heads are working properly (for example, are not clogged), whether the temperature of the glue or the print head is within tolerable limits, whether the vacuum supply of the plates is carried out correctly, whether the vacuum pump and the glue pump operate with pressures within tolerable limits, etc. Such data can be obtained inter alia with corresponding temperature or pressure sensors. The artificial intelligence open-loop and/or closed-loop control device 140 can then change, in accordance with the error analysis, for example one of the monitored parameters or change the composition of the glue or the printed image applied or the amount of glue or the composition of the glue applied per label 120 or change the applied contact pressure of the labels 120 onto the containers 113. Any change of operating parameters can take place fully automatically during the ongoing operation of the labeling device 100.

According to a further example, the artificial intelligence open-loop and/or closed-loop control device 140 of the labeling device 100 can react fully automatically to any batch change, for example, the change of the type of containers 113 to be labelled or the type of labels 120 used for labeling the containers 113. For example, the artificial intelligence open-loop and/or closed-loop control device 140 can decide that, in the case of a label change, less glue is now needed and correspondingly reduces the quantity of the glue used for labeling the containers 113, as a result of which the glue consumption can be optimized, or the glue composition can be varied, if appropriate in order thus to reduce the amount of glue required. In contrast to the operation of the labeling device according to the disclosure, the required application quantity of the glue and its composition are conventionally not checked so that glue is often wasted.

1. A labeling device for labeling objects, comprising:
a transport device for transporting the objects;
a label providing device;
a label transfer device for transferring labels;
a gluing device for applying glue to the labels;
an artificial intelligence open-loop and/or closed-loop control device; and
a sensor system having a plurality of sensor units for monitoring a plurality of operating parameters and quality parameters, and outputting a plurality of sensor data;
wherein
the artificial intelligence open-loop and/or closed-loop control device is designed to obtain the sensor data from the sensor system and to fully automatically control and/or regulate the setting of the operating parameters on the basis of these sensor data.

2. The labeling device according to claim 1, in which the operating parameters comprise parameters for the gluing device which comprise the amount, the pattern and the composition of the glue applied to the labels, which can be changed by the artificial intelligence open-loop and/or closed-loop control device according to a subset of the sensor data.

3. The labeling device according to claim 1, wherein the operation of the labeling device comprises transporting the objects with the transport device, dispensing of labels by the label providing device, transferring of labels by the label transfer device and applying of glue onto the labels by the gluing device.

4. The labeling device according to claim 1, in which the artificial intelligence open-loop and/or closed-loop control device comprises at least one of a deep (learning) neural network, multiplayer perceptron, convolutional neural network and recursive neural network.

5. The labeling device according to claim 2, in which the sensor system comprises first sensor units for monitoring parameters related to the glue and second sensor units for monitoring parameters related to the labels.

6. The labeling device according to claim 5, in which the sensor system comprises:
third sensor units for monitoring temperatures of elements of the labeling device;
fourth sensor units for monitoring pump pressures;
fifth sensor units for monitoring consumables;
sixth sensor units for monitoring cleaning processes; and
seventh sensor units for monitoring environmental parameters.

7. The labeling device according to claim 5, in which the first sensor units comprise a sensor unit for monitoring the composition of the glue.

8. The labeling device according to claim 7, in which the first sensor units comprise a sensor unit for monitoring the quantity of glue applied to the labels, a sensor unit for monitoring the viscosity of the glue, a sensor unit for monitoring the particle size of particles of the glue, a sensor unit for monitoring the temperature of the glue, and a sensor unit for monitoring the pattern of the glue applied to the labels.

9. The labeling device according to claim 5, in which the second sensor units comprise a sensor unit for monitoring the adhesion of the labels to the objects and a sensor unit for monitoring the positioning of the labels on the objects.

10. The labeling device according to claim 1, wherein the gluing device is designed to glue the labels according to the inkjet method and in particular comprises a plurality of individually controllable glue nozzles.
